(19) United States
(12) Patent Application Publication
(10) Pub. No.: US 2014/0052738 A1
(43) Pub. Date: Feb. 20, 2014

(54) Crowdsourced multimedia

(71) Applicants: Matt Connell-Giammatteo, Bloomfield, CT (US); Todd Berman, Wes Hartford, CT (US); Tim Maloney, Avon, CT (US); Jason P. Sage, Ellington, CT (US)

(72) Inventors: Matt Connell-Giammatteo, Bloomfield, CT (US); Todd Berman, Wes Hartford, CT (US); Tim Maloney, Avon, CT (US); Jason P. Sage, Ellington, CT (US)

(21) Appl. No.: 13/573,041

(22) Filed: Aug. 15, 2012

(51) Int. Cl. G06F 17/30

(52) U.S. Cl. CPC G06F 17/30058
USPC 707/748

(57) ABSTRACT

To align media files from different users embodiments of the invention:
a) selects from a plurality of uploaded media files a subset of media files that relate to a common event, each selected media file comprising an audio component;
b) for each of the selected media files, parses the selected media file into samples and assigning a score to each sample based on an amplitude within the respective sample;
c) at least pair-wise correlates a series of the scores for each pair of the selected media files to find time alignment among the at least pair; and
d) assembles at least some of the selected media files for which time alignment was found into a singular media file while maintaining the found time alignments and storing in a computer readable memory the singular media file.

### TECHNICAL FIELD

This invention relates generally to network operations for collecting and aggregating audio or audio-video clips uploaded from multiple user devices.

### BACKGROUND

Smartphones increasingly have the capability to record high quality audio, still pictures and video. Simultaneously a wide variety of services are now available for smartphone users to upload their photos and videos to a web server for sharing with their friends, and for example with services like YouTube® also with strangers. These can generally be described as remote hosting services, allowing the various users to store their own media files in a manner that those files are accessible by others. Some may provide additional software by which a user can edit their own photos or videos prior to remotely storing them for sharing.

Recently there has been some interest in combining the videos uploaded by different users. See for example JOE SUMNER: SYNCHRONIZING CROWDSOURCED MOVIES by Douglas MacMillan (Businessweek.com; Jul. 19, 2012) which describes a mobile app called Vyclone which the principals see as a tool for citizen journalists to weave together a documentary of a live news event. The article describes that the Vyclone system uses GPS to tag the individual videos with the location at which they were shot.

There is a growing concern for privacy among tech-savvy smartphone users, and many disable the GPS tagging feature of their phones so as not to reveal to strangers the vicinity in which they live and photograph their children. From the brief article noted above it would appear that if a user had their GPS tagging feature disabled when recording their video then at least other users would not be able to find it for their video editing. The example concerns home movies so it may be that only those uploading users who are aware of one another before uploading can utilize the service to make their respective video clips into a multi-angle movie. Additionally, the article describes that the users choose how the clips are organized in the final movie by toggling from one angle to the next using a video editor. This manual editing as well as the GPS tagging and inability to handle clips from unknown users appear a bit limiting. The teachings below overcome some of these shortfalls.

### BRIEF DESCRIPTION OF THE DRAWINGS

FIG. 1 is a logic flow diagram that illustrates operation of a method, and a result of execution by a server or similar such networked apparatus of a set of computer instructions embodied on a computer readable memory, in accordance with the exemplary embodiments of these teachings.

FIG. 2 is an example of time slices or samples parsed from an audio portion of an uploaded and selected media file according to one non-limiting example.

FIG. 3 illustrates digitized scores for media file samples as in FIG. 2, and shows several iterations of a correlation between a pair of media files in order to find time alignment according to an exemplary embodiment of these teachings.

FIG. 4 is a timing diagram illustrating one example of how these teachings may be employed to set multiple media files along a common event timeline using the time alignments learned from the correlating of FIG. 3.

FIG. 5 is a simplified block diagram of a server, a radio access network and multiple user computing devices which are exemplary devices suitable for use in practicing the exemplary embodiments of the invention.

### SUMMARY

In a first example embodiment of the invention there is a method which comprises:

a) selecting from a plurality of uploaded media files a subset of media files that relate to a common event, each selected media file comprising an audio component;

b) for each of the selected media files, parsing the selected media file into samples and assigning a score to each sample based on an amplitude within the respective sample;

c) at least pair-wise correlating a series of the scores for each pair of the selected media files to find time alignment among the at least pair; and

d) assembling at least some of the selected media files for which time alignment was found into a singular media file while maintaining the found time alignments and storing in a computer readable memory the singular media file.

In a second example embodiment of the invention there is an apparatus which includes at least one processor and at least one memory including computer program code. The at least one memory and the computer program code are configured, with the at least one processor and in response to execution of the computer program code, to cause the apparatus to at least:

a) select from a plurality of uploaded media files a subset of media files that relate to a common event, each selected media file comprising an audio component;

b) for each of the selected media files, parse the selected media file into samples and assign a score to each sample based on an amplitude within the respective sample;

c) at least pair-wise correlate a series of the scores for each pair of the selected media files to find time alignment among the at least pair; and

d) assemble at least some of the selected media files for which time alignment was found into a singular media file while maintaining the found time alignments and storing in a computer readable memory the singular media file.

In a third example embodiment of the invention there is a computer readable memory tangibly storing a program of computer readable instructions. These instructions comprise at least:

a) code for selecting from a plurality of uploaded media files a subset of media files that relate to a common event, each selected media file comprising an audio component;

b) for each of the selected media files, code for parsing the selected media file into samples and code for assigning a score to each sample based on an amplitude within the respective sample;

c) code for at least pair-wise correlating a series of the scores for each pair of the selected media files to find time alignment among the at least pair; and

d) code for assembling at least some of the selected media files for which time alignment was found into a singular media file while maintaining the found time alignments and storing in a computer readable memory the singular media file.

### DETAILED DESCRIPTION

Assume an interne based service to which different users upload their video clips. On a given day there may be uploads from multiple different events, the users uploading their own clips recording a given event such as a concert or dance recital may or may not know one another, and the various video clips for a given event may be uploaded over the course of several days or weeks. For a large venue event such as a concert or sports, the users may not only be recording from different angles but also from quite different distances from the stage or field; some close in and others in balcony-type seating. The teachings below demonstrate how these various clips, which in some embodiments may or may not be GPS-tagged, can be organized per event and automatically assembled along a continuous timeline (to the extent the aggregated clips record continuously).

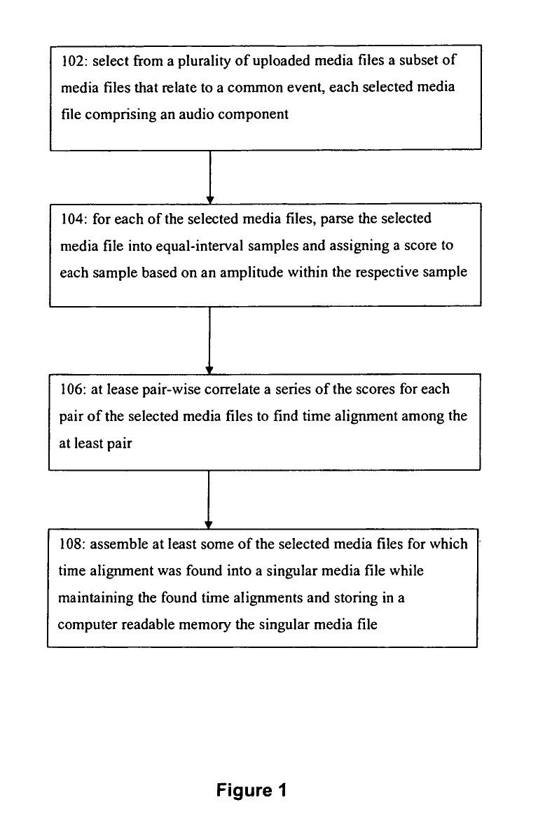

FIG. 1 is a logic flow diagram which gives an overview of one exemplary embodiment of these teachings. Following the overview each of the various distinct steps or elements shown at FIG. 1 is detailed with more particularity.

The logic flow diagram of FIG. 1 summarizes certain exemplary embodiments of these teachings from the perspective of the service to which the individual users upload their video clips, and this service may be embodied in one or more servers to be detailed further below. FIG. 1 may be considered to illustrate the operation of a method, and actions relevant to executing software/computer program code that is tangibly embodied in or on a memory which may physically be a part of the server or which is accessible by the server. Such embodied software may be software alone, firmware, or a combination of software and firmware.

FIG. 1 may also be considered to represent a specific manner in which components of such a server or servers are configured to cause the server to operate, for example where at least some portions of the invention are embodied in hardware such as an application specific integrated circuit ASIC or one or more multi-purpose processors in the server(s). The various blocks shown at FIG. 1 may also be considered as a plurality of coupled logic circuit elements constructed to carry out the associated function(s), or specific result of strings of computer program code or computer readable instructions that are tangibly stored in one or more computer readable memories.

Block 102 summarizes that the server(s) select from a plurality of uploaded media files a subset of media files that relate to a common event. As will be seen from below, the media files are aggregated together via audio, and so each selected media file comprises an audio component. Users upload the plurality of media files and they may be from different events and they may be audio files, audio-visual files, or some other electronic recording of an event or portion thereof. The server puts these into separate ‘buckets’, each bucket corresponding to a unique event.

Then at block 104, for each of the selected media files the server(s) parse the selected media file into samples each spanning the same length of time, which block 104 terms as equal-interval samples. For each sample of each of those selected media files the server(s) assigns a score, based on an amplitude within the respective sample.

In the examples below the score is based on the peak audio amplitude (positive or negative peak) but in other embodiments an average audio amplitude may be used for the score with some weighting to reflect variance across the average so that an average audio amplitude with little variance is weighted differently than an average audio amplitude across a widely divergent peak and valley amplitude. So long as the same scoring rules are applied across all the samples there are a multitude of ways to implement the amplitude scoring, which effectively digitizes the amplitudes by assigning a number to each sample. Further, the server(s) may perform some normalization across the different selected media files to account for different audio recording levels of the different devices which actually did the recording to allow for a more effective matching at block 106.

Now with the scored samples for all the selected media files, block 106 describes that for a series of the scores a correlation is performed among at least pairs of distinct selected media files. The series is the same length vis a vis number of samples and so same-length series of scores are correlated to find a match, which shows where exactly the pair of media files are aligned in time. The example below details pair-wise correlating but this can be readily extended to correlate in parallel any number N of selected media files, where N is any integer greater than one.

This correlation finds time alignment, if any, among the correlated pair. For example, assume the common event is a dance recital that in truth lasts an hour, but the server is unaware of that total event duration when it begins the correlation phase of FIG. 1. The correlation finds the time overlap among any two media files. Assume two selected media files of 10 minutes duration each which were both recorded within the first 17 minutes of the recital. The correlation will test the series of scores of one clip against all possible series of scores of the other, and because these two files necessarily have at minimum a 3 minute overlap there will be a match found somewhere in that overlapped time. In this manner the correlation time aligns the pair of selected files. But the correlation would not be able to find time alignment between either of those two files and a third selected media file whose start time is after 17 minute following the recital's start because there is no time overlap of the third with either of the first two selected media files. One or more intervening files will be needed to time align the third file in relation to the first two. This correlation continues in that manner until time alignment is found among as many of the media files as can be matched across a series of scores.

Since there may be a time gap between aligned ones of the files and one or more others in the common-event bucket, then at least some but not necessarily all of the media files first selected at block 102 can be synchronized to a common time line. The server(s) at block 108 therefore assemble at least some of those selected media files for which time alignment was found into a singular media file, while maintaining the found time alignments. This singular media file is then stored in a computer readable memory, for later download by a user who may or may not have contributed one of the selected media files or to other persons. Or in another embodiment the singular media file is ‘pushed’ to those users who requested it, such as attached to an email sent by the server.

Now consider a few example implementations of the selection made at block 102. Media files for a given event may be considered to be put in an event-specific ‘bucket’ as mentioned above, which in practice may be a metadata tag which the server adds or a way of organizing the selected files using the memory address space such as by putting them in an event-specific virtual folder. The server can use any one or more of the following techniques to select which media files go into which event-specific bucket.

If a given media file is uploaded with GPS tagging the server can simply look at the file's GPS location and the media file's timestamp and set thresholds about those parameters. Then any other uploaded media files having GPS tags reflecting a location within the threshold distance of that first file in the bucket, and also having a timestamp within some other threshold time of the timestamp of the first media file in the bucket, will be assumed to be for a common event and placed in the bucket for that event. The thresholds may be tailored to the specific venue at which the event was held; a college or professional football game may use a location threshold on the order of 500 meters and a timestamp threshold on the order of 4 hours so as to capture also media files of immediately pre- and post-game recordings, whereas an indoor dance recital might utilize a much smaller location threshold. The first user to upload a media file for a given event may be queried on a graphical display interface of their smartphone, tablet or other computer screen as to the venue size and event duration, which the server uses to choose appropriate thresholds.

In another embodiment the user uploads the media file with a digital identity of the event, for example by scanning a UPC bar code printed on the event ticket. In this implementation the user will then upload two distinct files; the media file and the photo of the ticket bar code. If for example the user uploads his/her media file the server can check it for the GPS and timestamp, and if there is none the graphical user interface at the user's end queries the user whether he/she has a picture/image of the event ticket with the bar code. The user takes the picture, selects yes, and then uploads the image to the server. If the user does not upload a bar code image the user may manually select an event bucket as detailed below.

In a still further embodiment the user can manually select the event-specific bucket. In this case there will be a searchable list of the different buckets, searchable by one or more of event date, event location, name of the venue at which the event was held and event type (for example, football game, chorus concert, birthday party). If the bucket already exists the user manually selects it and then uploads their media file at a graphically displayed prompt, or in another embodiment the user selects the event first and then uploads his/her media file at the prompt. If there is no pre-existing bucket the user can create one and other users uploading media files for that event will find it in the searchable database listing.

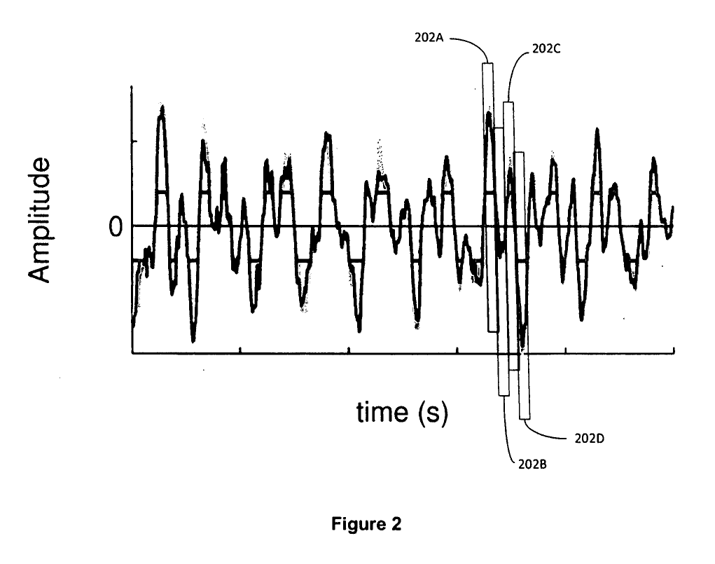

Now with the uploaded media files tagged to a particular event-specific bucket the selected media files for one specific event are parsed into samples and scored as block 104 of FIG. 1 describes. FIG. 2 shows the sample parsing graphically for one small section of raw audio for one selected media file. Only four such samples are shown but the process is repeated across the entire media file, or at least a large enough portion so as to avoid or minimize false positives in the correlating phase detailed below. The raw audio file is divided into positive and negative amplitudes; sample 202A and 202C exhibit a positive amplitude whereas samples 202B and 202D exhibit negative amplitudes. The time interval per samples needs to be sufficiently short that in general multiple peaks will not be aggregated for that would frustrate the correlation. Some exceptions to this principle are allowed because the correlation is satisfied within some minimal confidence level so the lack of an exact match among all the scored series of samples is tolerable without resulting in false positives generally. The inventors' prototype software utilized a sample width of 16 bytes with excellent results.

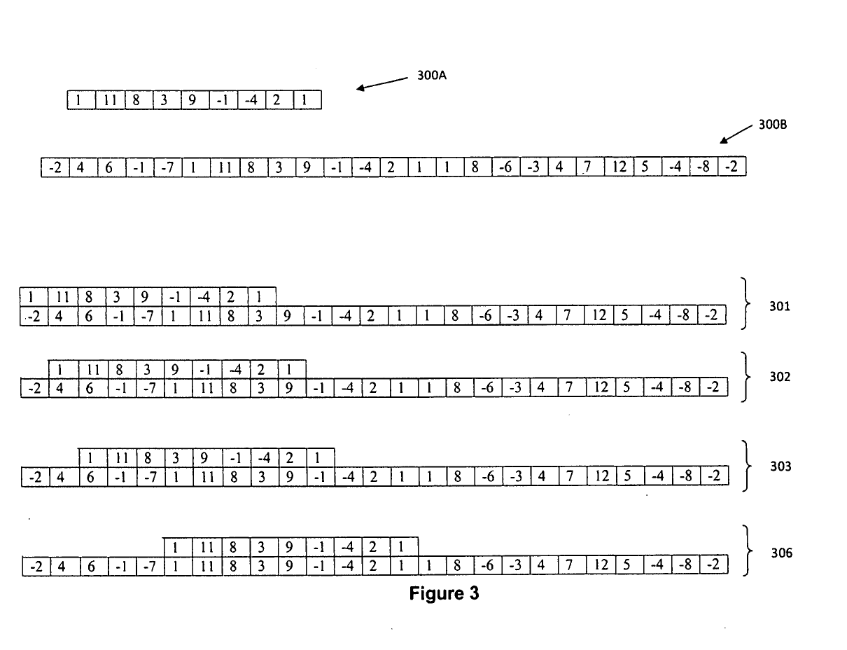

As noted above there are a variety of techniques for how to score the samples, but it is important that the scoring parameters or rules be applied consistently among all the samples of all the media files that are selected to a given event specific bucket. For the correlation example shown at FIG. 3 an integer value indicting peak height relative to the zero amplitude axis was assigned to the maximum absolute peak within the sample bounds, and the values were set positive or negative after identifying the absolute peak height to represent whether the peak was above or below the zero-amplitude axis.

Some other non-limiting examples of how to score the samples include extracting the amplitude data from each of the selected media files and building an array of the ratios (differences) for each file by comparing the amplitude differences of adjacent sound samples for each individual media file. So for example in the first media file 300A at FIG. 3 for the first column the ratio would be the difference between the first and the second columns which is 1−11=−10; and for the second column the ratio would be the difference between the second and the third columns which is 11−8=3. For the first and second columns of the second media file 300B the respective differences are (−2)−4=−6 and 4−6=−2. These differences are computed for the entire series being compared. Then the arrays of the correlated pair of audio files are compared one by one (column by column as shown in FIG. 3) to attain a total score by subtracting the ratios/values per position/column through the whole series being compared. This technique was used in the inventors' prototype with very positive results, but in this case the series of sample values being correlated was the entire length of the shorter of the two media file samples so the additional confirmation step noted above was not needed. Then similar to that shown at FIG. 3 for 301, 302, 303 and 306, the process repeats iteratively while shifting alignment of each array by one bit/column position for each iteration (or some other systematic offset so long as every potential alignment can still be checked if needed) until a match is found or there are no further offsets to test.

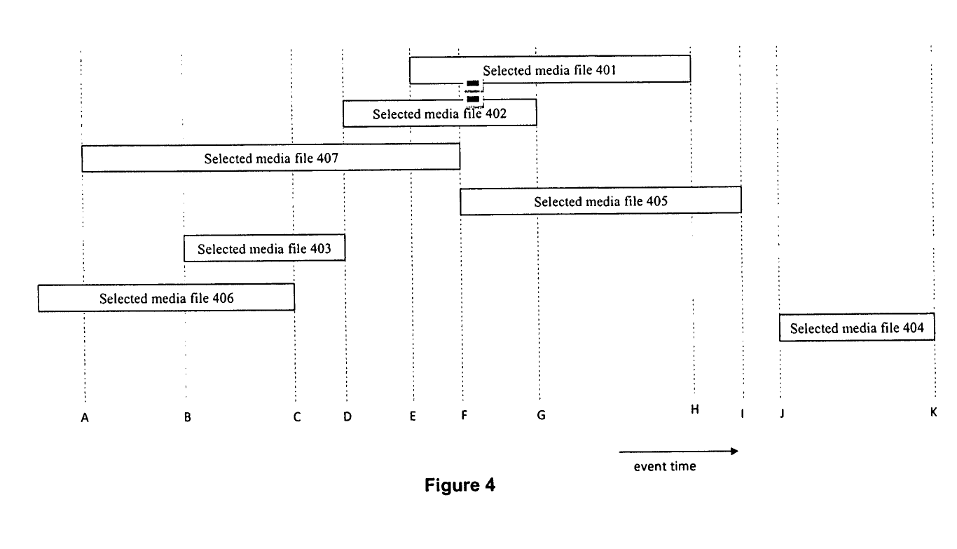

If we consider the above comparisons of file values 300B being subtracted from file values 300A as a forward correlation, then this technique also uses a reverse correlation which is similar to that described above except now the order of the arrays are reversed, so for the FIG. 3 example the reverse correlation would subtract the difference values from file 300A from those of file 300B. This reverse correlation also is repeated systematically at iterative position offsets of one array against another. This forward and reverse correlation helps determine which audio file starts first, which is important to synchronization as will be seen below with reference to FIG. 4.

Note that the difference testing in the technique described immediately above results in a lowest score for the offset position of the arrays of the two media files 300A and 300B which indicates which one comes first in time. The offset position is then used to calculate the actual time to offset the respective media files when assembling them in the proper sequence because each sound sample represents a predetermined measure of time.

FIG. 3 illustrates a non-limiting example of the correlating done at block 106 of FIG. 1. There are two selected media files being compared at FIG. 3, for the first one there is a series of nine scores 300A and for the second media file there is are 25 scores 300B shown but for the correlation the series length can be no longer than 9 in this example. The series represent scores of consecutive samples of the underlying selected media file. Using a series length of only 9 is to more directly show the concept; in practice the series length will be far larger in order to avoid false positive matches among media files.

The correlation proceeds in iterations with each iteration ‘slipping’ by one bit position (one sample value) the series values for one media file against those of the other. Iteration #1 at 301 of FIG. 3 shows the values for the different media files in different rows of the same table as the values are presented at 300A and 300B. The reader will appreciate that the column-wise matching across the nine columns being correlated for iteration #1 at 301 do not match and so the process moves to the next iteration. Depending on the match thresholds in use it may be that the third, sixth and ninth columns in iteration #1 are considered close enough to be a match but the correlation and the decision per iteration is for all scores across the series being compared, and so the test for a match across those nine columns fails in this first iteration 301.

For iteration #2 at 302 the upper-row series of scores 300A is slipped one column while the larger lower-row set of scores 300B remains unchanged. Still there is no match across the nine columns being compared and so the upper-row series of scores are slipped again one bit as shown at 303 which is iteration #3. The process continues until either a series-wide match is found for a given correlation iteration or there are no more series remaining of the lower-row scores (the larger set) against which to compare the upper-row scores (the smaller set which in FIG. 3 defines the series length).

FIG. 3 does not specifically illustrate the next few iterations but next shows iteration #6 at 306 in which there is a match across the nine columns of scores being compared. The processor concludes that a match is found and the end result is that aligning the corresponding samples for these two selected media files time-aligns them to one another.

Since the series 300A is shorter than the total number of scores 300B, this means each iteration will have the exact same series of scores 300pA for the first media file but a different series taken from the whole set of scores 300B for the second media file. For the scores 300B of the second selected media file this means at iteration #2 (302) the series is {4, 6, −1, −7, 1, 11, 8, 3, 9} in the second through tenth columns.

The above description assumed the scores per sample were compared. This is a non-limiting embodiment for how the correlation may be performed. In another embodiment the sample scores per column may be multiplied and the iteration decision is based on there being a sufficiently high value in the summation of the column-wise products in a given iteration, as compared to other iteration decisions. The sufficiently high value may be taken from simply multiplying for one series the values by themselves and summing those products, which would represent the value of an exact match. Some allowance may be made for rounding errors inherent in quantizing the amplitude peaks so the threshold to decide whether there is or is not a match may be reduced a bit, say by 1 to 3% for a given series of scores. Since negative amplitudes are reflected in the scores in this example, some of the column mis-matches will yield a negative number which will hold down the total summation of the column-wise products.

The series length itself should be sufficiently long to avoid false positive matches. Once a match is found across a given pair of media sample series scores then the remainder of the overlapped portions of those two media files may be correlated to further cull false positive matches. This is what the inventors' prototype software program does and this was found to be quite effective in attaining proper alignment of media files of a common event which were recorded from vastly different angles and distances and using different types of recording devices.

FIG. 4 illustrates a schematic diagram showing seven selected media files for which time alignment was found for six of them, arranged along a common timeline corresponding to the underlying event. This figure illustrates how the six selected media files for which time alignment was found are assembled into a singular media file as noted at block 108 of FIG. 1. Time boundaries for each selected media file are shown by the dotted line vertical axes each bearing a different letter designation.

There are seven selected media files in the event and the nomenclature of FIG. 4 reflects the order in which the processing system takes up correlating file pairs. The first two selected media files taken up for correlation are 401 and 402; these may be chosen randomly or the longest length files may be chosen to increase the odds that a match will be found. The two initially chosen selected media files 401 and 402 are correlated and a match is found, assumed to be along the series of samples represented by the bolded portions along those media files 401, 402. To confirm the match then the sample scores are correlated along the entire length of the media files from time E through time H. Assume this wider correlation confirms the match.

Then another selected media file 403 is chosen from the event-specific bucket and correlated against media file 401. No match is found, so file 403 is correlated against file 402. Again no match is found so the server puts aside file 403 and chooses another one, file 404. The server follows the same process with media file 404 as it did with file 403 and assume the result is the same; no match.

The server's processing system then chooses media file 405, correlated against file 401 and finds a match across a series of sample scores. The processing system knows the start and end times of these media files 401, 405 and aligning the matched series of scores sees that they overlap between time F and time H, and so widens its correlation across that entire span of samples to confirm the match. It is also clear in this example that media file 405 overlaps with media file 402 so the processing system may also confirm by correlating across the sample scores of those two files between times F and G.

At this juncture the server knows the event timeline between times D and I. The processing system takes another selected media file 406 from the event-specific bucket and correlates it against media file 401. No match is found, so file 406 is correlated against file 402 and again against media file 405, and in both cases no match is found. The server puts aside file 406 and chooses the last remaining selected file 407.

Correlating file 407 against 401 finds a match, which the processing system confirms by correlating again across the entire time span between E and F. As further confirmation it may also correlate file 407 against file 402 for the scored samples which lie between times D and F.

Adding file 407 expands the known timeline from between D and Ito between A and I and there are no remaining files in the bucket which have not yet been correlated, so the processing system re-checks those files which it put aside earlier for lack of a match during their first correlation, namely files 403, 404 and 406. In this case these files have already been correlated against files 401 and 402 and so all that is needed is to check against those portions of the timeline which were not checked in their respective earlier correlations. So a scores series from file 403 is tested at least against the sample scores of media file 407 between times A through D and as FIG. 4 illustrates a match is found which time aligns file 403 between times B and D.

A similar re-correlation process is followed for files 404 and 406; a match is found for 406 but not for 404 and so file 406 is placed on the event timeline as shown and file 404 is again put aside. Like file 407, the addition of file 406 adds to the timeline and so it cannot be assumed that file 404 cannot be matched anywhere. The processing server takes up file 404 for a third time, correlates at least against that portion of file 406 that adds to the timeline prior to time A, and still finds no match. File 404 is thus an ‘orphan’ file, which cannot be automatically time-aligned to any of the other media files in the bucket. Thus it will not be added to the singular media file that results from FIG. 4 unless manually selected by a user for inclusion. In that case the user can choose where in the timeline of the event this orphan file is to be positioned.

The processing system then compiles the various time-aligned media files into a singular media file and stores it in a memory for download to requesting users. The time overlapped portions, such as between times A and H of FIG. 4 during which different groups of media files overlap, can be handled in a number of different ways.

For automatic processing where the user does not make a preference, the processing system may discard low-quality files or files that are shorter in time than some predetermined minimum threshold, to prevent a grainy portion in the end result file and rapidly shifting camera angles. From these files meeting minimum quality and duration criteria the overlapped portion from each file can be clipped at some mid-point (but without violating the minimum duration limit), so for example if we assume file 403 is discarded for quality or duration issues then the earlier portion of file 407 might be clipped while the later portion of file 406 is clipped and the two are joined at some mid-point somewhere around time B. In another embodiment the switch from one uploaded media file to another in the output singular media file may be based on their respective audio profiles. Since the different uploaded/selected media files are from different users they each exhibit a unique camera angle (assuming it is audio/video files that are uploaded). In this embodiment the shifting point from one media file to another is based on amplitude peaks and valleys in the time-overlapped portion of those files (without normalizing amplitude) so as to avoid wide changes in volume at the shifting point due to one camera angle/media file being much farther from the sound source and hence softer in volume and the other being much nearer and louder. For example, an appropriate shifting point in this case might be a generally lower-volume section in the time-overlapped portion of the relevant media files. This can be found by comparing an amplitude averaging metric across different same-duration sections of the time-aligned portion of the media files; where the percentage difference between this averaging metric for the two relevant files is the least can be selected as the switching point for the output singular media file. However implemented, this joining may be an abrupt shift from one uploaded file to the other, or a split screen view, or a fade out and in.

The server(s) may provide the above crowdsourcing service to users at least partly through an software-defined interface displayed on a graphical user interface of a user's computer, such as for example a smartphone; tablet, laptop or desktop computer, or a wearable computer such as eyeglasses with a near-field micro-display which projects the graphical user interface within an inch or so of the user's eye(s). This software-defined interface may be embodied as an application (client) stored on the user' local computing device or from an app store.

This interface on the user's side may provide various options for the user to customize the end result singular media file. For example, the user may select to manually assemble the various selected media files once the server processing system sets the time alignment; or select where the transitions are to occur, or select that one or more uploaded and selected media files be retained in or excluded from the end result singular media file. Additionally the interface may enable the user to add a title to lead into the singular media file, or text or graphical demarcations overlain over the video portion of the singular media file at selected locations of it such as for example “this is me!” or “ [symbol] ” with an arrow pointing to a particular individual in the video.

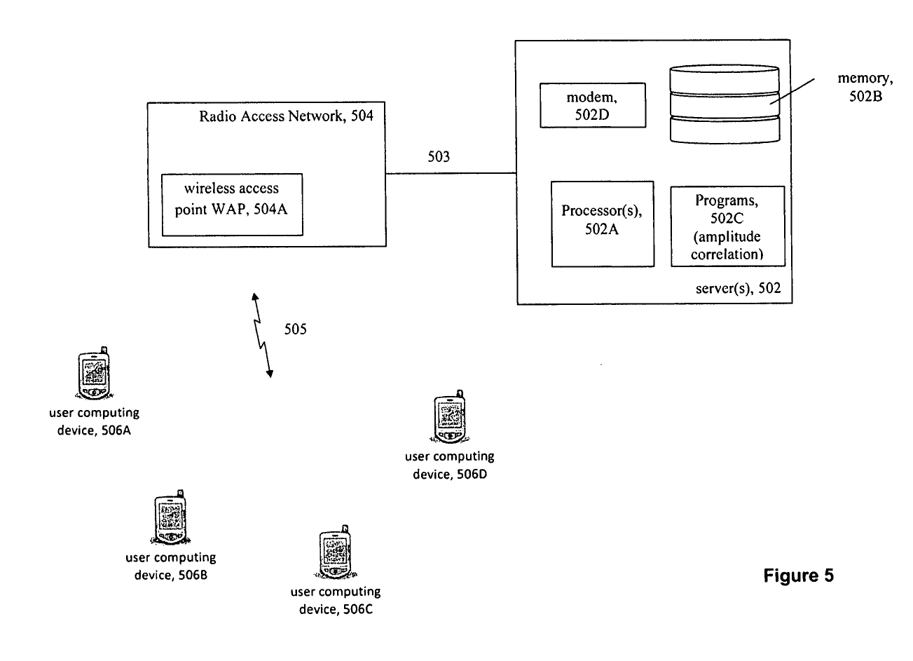

FIG. 5 illustrates a simplified block diagram of various electronic devices and apparatus that are suitable for use in practicing the exemplary embodiments of this invention. In FIG. 5 there is one or more servers 502 providing the above services to users shown as user computing devices 506A-D. The server includes one or more processors 502A which execute software programs 502C stored in one or more computer readable memories 502B which may be within the server 502 or which may be external of it but accessible via some data and control interface. For example one of the programs 502C tangibly stored in or on the memory 502B is detailed above as correlating the amplitudes of different uploaded and selected media files. These uploaded media files are also stored in the memory 502B, as is the resulting singular media file for later download to any of the users 506A-D.

The server 502 is connected to the Internet and therefore is communicatively coupled to a radio access network 504 via a data and control channel 503 (and via a core network, not shown). In fact there are multiple radio access networks to which the server 502 is communicatively coupled, some under the same core network and others under different core networks depending on the radio access technology and the service provider. Each radio access network 504 includes multiple wireless access points WAP 504A which establish a bidirectional wireless connection 505 with the user computing devices 506A-D. In this manner the user computing devices 502A-D may upload their individually recorded media files to the server 502 and its memory 502B, enter any user preferences on the user-side software-defined interface, and download the resulting singular media file.

While FIG. 5 assumes all the user computing devices 506A-D utilize the same radio access network 502, this is a non-limiting deployment; the user computing devices may upload and/or download as noted above using different radio access networks, or may do so via a hardwired connection such as for example uploading their recorded media file to a home desktop computer and uploading directly to the Internet rather than through a wireless service.

It is not necessary that the server restrict download of the singular media file to only those user computing devices, or their registered users, who have uploaded a media file for the underlying event, different implementations may make the singular media file available to any registered user or to the public even without registration, and it may allow a user option to restrict access of a particular singular media file which was compiled in view of some preferences that user entered.

At least one of the programs 502C in the server(s) 502, when executed by the one or more processors 502A, enables the server to provide the services detailed herein, for example according to the general steps outlined at FIG. 1. In this regard the exemplary embodiments of this invention may be implemented at least in part by computer software 502C stored on the memory 502B which is executable by the processor(s) 502A of the server(s) 502, or by hardware or a combination of tangibly stored software and hardware (and tangibly stored firmware).

The above more detailed implementations show that for the process flow shown generally at FIG. 1 the selecting of block 102 comprises associating at least one of the uploaded media files with the common event which is manually chosen by a user who uploaded the at least respective media file. In a particular implementation the common event is manually created by a user who uploaded at least one of the media files.

For the parsing stated at block 104 of FIG. 1, the above examples show that all of the samples across all of the selected media files span an equal time interval.

Further from the non-limiting examples above, the correlating stated at block 106 of FIG. 1 comprises, after finding correlation across the series of the scores for a given pair of the selected media files, correlating across a larger number of the scored samples of the given pair which overlap in time to confirm the time alignment, and in this case the assembling at block 108 of FIG. 1 is limited to only those selected media files for which the time alignment was confirmed. In the specific embodiment detailed above which the inventors used as a prototype, the correlating comprises computing amplitude differences between samples in the series of a same selected media file. While adjacent sample amplitudes were differenced in that prototype a similar result can be obtained using non-adjacent sample amplitude values, so long as the same positions are used for the differencing in both arrays (both media samples being correlated). Further in that prototype the correlating comprised finding column-wise differences between the amplitude differences for the series of scores being pair-wise correlated; and summing the differences between samples of the same selected media file to find a total score across the series.

Further in relation to the assembling of block 108 at FIG. 1, then the above examples further show that this may comprise at least one of including or excluding one or more selected media files as indicated by a user. This assembling may also comprise transitioning between at least two of the time-overlapped selected media files according to a user-defined preference, and in another example above the assembling is restricted to the selected media files which meet a minimum threshold for at least one of quality and duration.

Various embodiments of the computer readable memory 502B include any data storage technology type which is suitable to the local technical environment, including but not limited to semiconductor based memory devices, magnetic memory devices and systems, optical memory devices and systems, fixed memory, removable memory, disc memory either individually or in a RAID, flash memory, DRAM, SRAM, EEPROM and the like. Various embodiments of the processor(s) 502A include but are not limited to general purpose computers, special purpose computers, digital microprocessors, and multi-core processors.

Various modifications and adaptations to the foregoing exemplary embodiments of this invention may become apparent to those skilled in the relevant arts in view of the foregoing description. Further, some of the various features of the above non-limiting embodiments may be used to advantage without the corresponding use of other described features. The foregoing description should therefore be considered as merely illustrative of the principles, teachings and exemplary embodiments of this invention and in itself representing a limitation of the breadth of the invention.

What is claimed is:

1. A method comprising:
selecting from a plurality of uploaded media files a subset of media files that relate to a common event, each selected media file comprising an audio component;
for each of the selected media files, parsing the selected media file into samples and assigning a score to each sample based on an amplitude within the respective sample;
at least pair-wise correlating a series of the scores for each pair of the selected media files to find time alignment among the at least pair; and
assembling at least some of the selected media files for which time alignment was found into a singular media file while maintaining the found time alignments and storing in a computer readable memory the singular media file.

2. The method according to claim 1, wherein the selecting comprises associating at least one of the uploaded media files with the common event which is manually chosen by a user who uploaded the at least respective media file.

3. The method according to claim 1, wherein the common event is manually created by a user who uploaded at least one of the media files.

4. The method according to claim 1 wherein all of the samples across all of the selected media files span an equal time interval.

5. The method according to claim 4, wherein:
the correlating comprises, after finding correlation across the series of the scores for a given pair of the selected media files, correlating across a larger number of the scored samples of the given pair which overlap in time to confirm the time alignment; and
the assembling is limited to only those selected media files for which the time alignment was confirmed.

6. The method according to claim 5, wherein the assembling comprises at least one of including or excluding one or more selected media files as indicated by a user.

7. The method according to claim 5, wherein the assembling comprises transitioning between at least two of the time-overlapped selected media files according to a user-defined preference.

8. The method according to claim 4, wherein:
the correlating comprises computing amplitude differences between samples in the series of a same selected media file.

9. The method according to claim 8, wherein the correlating further comprises:
finding column-wise differences between the amplitude differences for the series of scores being pair-wise correlated; and
summing the differences between samples of the same selected media file to find a total score across the series.

10. The method according to claim 1, wherein the assembling is restricted to the selected media files which meet a minimum threshold for at least one of quality and duration.

11. An apparatus comprising:
at least one processor and at least one memory including computer program code;
wherein the at least one memory and the computer program code are configured, with the at least one processor and in response to execution of the computer program code, to cause the apparatus to at least:
select from a plurality of uploaded media files a subset of media files that relate to a common event, each selected media file comprising an audio component;
for each of the selected media files, parse the selected media file into samples and assigning a score to each sample based on an amplitude within the respective sample;
at least pair-wise correlate a series of the scores for each pair of the selected media files to find time alignment among the at least pair; and
assemble at least some of the selected media files for which time alignment was found into a singular media file while maintaining the found time alignments and storing in a computer readable memory the singular media file.

12. The apparatus according to claim 11, wherein the selecting comprises associating at least one of the uploaded media files with the common event which is manually chosen by a user who uploaded the at least respective media file.

13. The apparatus according to claim 11, wherein the common event is manually created by a user who uploaded at least one of the media files.

14. The apparatus according to claim 11 wherein all of the samples across all of the selected media files span an equal time interval.

15. The apparatus according to claim 14, wherein:
the correlating comprises, after finding correlation across the series of the scores for a given pair of the selected media files, correlating across a larger number of the scored samples of the given pair which overlap in time to confirm the time alignment; and
the assembling is limited to only those selected media files for which the time alignment was confirmed.

16. The apparatus according to claim 15, wherein the assembling comprises at least one of including or excluding one or more selected media files as indicated by a user.

17. The apparatus according to claim 14, wherein:
the correlating comprises computing amplitude differences between samples in the series of a same selected media file.

18. The apparatus according to claim 17, wherein the correlating further comprises:
finding column-wise differences between the amplitude differences for the series of scores being pair-wise correlated; and
summing the differences between samples of the same selected media file to find a total score across the series.

19. A computer readable memory tangibly storing a program of computer readable instructions comprising:
code for selecting from a plurality of uploaded media files a subset of media files that relate to a common event, each selected media file comprising an audio component;
for each of the selected media files, code for parsing the selected media file into samples and assigning a score to each sample based on an amplitude within the respective sample;
code for at least pair-wise correlating a series of the scores for each pair of the selected media files to find time alignment among the at least pair; and
code for assembling at least some of the selected media files for which time alignment was found into a singular media file while maintaining the found time alignments and storing in a computer readable memory the singular media file.

20. The computer readable memory according to claim 19, wherein:
the code for correlating operates to compute amplitude differences between samples in the series of a same selected media file, to find column-wise differences between the amplitude differences for the series of scores being pair-wise correlated; and to sum the differences between samples of the same selected media file to find a total score across the series.
